(19) United States
(12) Patent Application Publication
(10) Pub. No.: US 2024/0299903 A1
(43) Pub. Date: Sep. 12, 2024

(54) METHOD FOR PREPARING ADSORBENT FROM INDUSTRIAL VERMICULITE, ADSORBENT AND APPLICATION THEREOF

(71) Applicants: SOUTHWEST UNIVERSITY OF SCIENCE AND TECHNOLOGY, Mianyang (CN); Changchun lantian high-tech seling materials Co.,LTD, Chabgchun City (CN)

(72) Inventors: Hongjuan SUN, Mianyang (CN); Tongjiang PENG, Mianyang (CN); Yue QING, Mianyang (CN); Liming LUO, Mianyang (CN); Yan XU, Changchun City (CN)

(21) Appl. No.: 18/214,069

(22) Filed: Jun. 26, 2023

(30) Foreign Application Priority Data
Mar. 10, 2023 (CN) 202310224875.9
Apr. 25, 2023 (CN) 202310453459.6

(51) Int. Cl. B01J 20/12; B01D 53/02; B01J 20/28; B01J 20/30; B01J 20/34

(52) U.S. Cl. CPC B01J 20/12; B01D 53/02; B01J 20/28004; B01J 20/3021; B01J 20/3028; B01J 20/3042; B01J 20/3078; B01J 20/3483; B01D 2252/10; B01D 2257/7027; B01J 2220/4806

(57) ABSTRACT

Provided are a method for preparing an adsorbent from industrial vermiculite, an adsorbent and application thereof. The method comprises steps: flaking and de-polluting the raw industrial vermiculite ore to obtain industrial vermiculite fine flakes; grinding the industrial vermiculite fine flakes to obtain industrial vermiculite powder; mixing the industrial vermiculite powder with a binder and granulating it to obtain an industrial vermiculite granular; and post-treating the industrial vermiculite granular to obtain the adsorbent. The adsorbent is prepared by the method. Applications may include purification of benzene gases such as toluene, sewage treatment, horticulture, soil improvement and applications in agricultural carriers. The adsorbent of the disclosure has the advantages of high cation exchange capacity, large internal specific surface area, strong adsorption of toluene and lightweight porous, etc. Moreover, the preparation method of the disclosure is simple, green, low production cost and easy to be produced on a large scale.

### CROSS-REFERENCE TO RELATED APPLICATION

The present application claims priorities from China Patent Applications No. 202310224875.9 and 202310453459.6, filed on Mar. 10, 2023 and Apr. 25, 2023, respectively, in the State Intellectual Property Office of P. R. China, the disclosures of which are incorporated herein in its entirety by reference.

### TECHNICAL FIELD

The disclosure relates to the field of functional mineral materials prepared from non-metallic mineral raw materials, and particularly relates to a toluene adsorbent prepared from industrial vermiculite and its method and application.

### BACKGROUND

Benzene is a general term for the derivatives of benzene, including all aromatic compounds in a broad sense and BTEX in a narrow sense, namely benzene, toluene, ethylbenzene and xylene. Due to production and living pollution, benzene is widely detected in human living environment, and it has strong harmful effects on human body and environment. For example, toluene is a common organic additive in the petroleum, pharmaceutical and chemical industries, and is one of the major causes of increased ozone concentration, global warming and regional photochemical smog pollution due to its high volatility and ease of entry into the atmosphere. Toluene is seriously toxic to humans and animals, and prolonged exposure to an environment containing toluene can cause a variety of pathologies in humans, including nerve damage and cell carcinogenesis. Deep toluene poisoning can have serious effects on the central nervous system, manifested as strong excitation or inhibition of nerves, such as restlessness, dizziness, and drowsiness.

Industrial vermiculite is a class of layered silicate minerals containing vermiculite crystal layers, and an important non-metallic mineral. With great internal specific surface area, high cation exchange capacity and strong adsorption properties, industrial vermiculite can be used as catalyst, adsorbent and soil heavy metal stabilizer, etc. At present, more studies have been reported on the use of vermiculite adsorption properties to treat heavy metal ions such as Cr³⁺, Cu²⁺, Pb²⁺, Ag⁺, Cd²⁺ in industrial and domestic wastewater, while studies on the adsorption of organic gaseous pollutants such as benzene and the technology for preparing industrial vermiculite adsorbents have not been reported.

At present, the most common method for the treatment of benzene pollution is adsorption, commonly used adsorbents are activated carbon, activated carbon fiber and molecular sieve, etc. Many adsorbents generally have uneven results, high raw material costs, complex modification processes, easy aging and recycling difficulties after the use of adsorbents. For example, conventional toluene adsorbents include activated carbon, zeolite molecular sieve, silica aerogel, etc. Among them, benzene is a weakly polar material, and activated carbon has a large adsorption capacity for toluene, but it has uneven pore size distribution, low content of surface functional groups, easy to poisoning and other problems, and most of them need complex modification process and high cost of raw materials; zeolite molecular sieve has low specific surface area and porosity, and the adsorption capacity for benzene is low, and the synthesis and preparation process is complicated and the cost of raw materials is high; silica aerogel has low density, large specific surface area and surface energy, the adsorption of toluene up to 5-200 mg/m³, but due to its uneven pore size distribution, the preparation process is complex, limiting the application as an adsorbent.

Therefore, it is important to develop an efficient and low-cost benzene adsorbent.

### SUMMARY

The objects of the present disclosure are to solve one or more problems in the related art. For example, one of the objects of the present disclosure is to achieve efficient adsorption and purification of benzene.

In order to achieve the above purpose, one aspect of the present disclosure provides a method of preparing toluene adsorbent from industrial vermiculite.

The method may comprise the following steps: flaking and de-polluting the raw industrial vermiculite ore to obtain industrial vermiculite fine flakes; grinding the industrial vermiculite fine flakes to obtain industrial vermiculite powder; mixing the industrial vermiculite powder with a binder and granulating it to obtain an industrial vermiculite granular; post-treating the industrial vermiculite granular to obtain benzene adsorbent from industrial vermiculite, i.e. the adsorbent.

Alternatively, the cation exchange capacity of the industrial vermiculite fine flakes may be 30 to 180 mmol/100 g.

Alternatively, the particle size of industrial vermiculite powder may be in a range of −100 mesh to −325 mesh.

Alternatively, the binder may comprise at least one of an inorganic binder and an organic binder, wherein, the inorganic binder may include one or more of bentonite powder, kaolin powder, alutite clay powder, seafoam clay powder and illite clay powder; the organic binder may include one or more of sodium carboxymethyl cellulose, polyacrylamide, polyvinyl alcohol, and MS modified silane.

Alternatively, under the condition where the binder comprises only the inorganic binder, the mass ratio of the industrial vermiculite powder to the inorganic binder may be 1:0.2 to 0.8;

Under the condition where the binder comprises only the organic binder, the mass ratio of the industrial vermiculite powder to the organic binder may be 1:0.02 to 0.08;

Under the condition where the binder includes the inorganic binder and the organic binder, the mass ratio of the industrial vermiculite powder, the inorganic binder and the organic binder may be 1: (0.15 to 0.6):(0.015 to 0.06).

Alternatively, pelletizing methods include extrusion pelletizing method by extruder, circular pot rotary pelletizing method or circular disc rotary pelletizing method.

Alternatively, the shape of the industrial vermiculite granular may include cylindrical or spherical, wherein, the cylindrical granular may have a diameter of 1 mm to 5 mm and a length of 2 mm to 10 mm; the spherical granular may have a diameter of 1 mm to 5 mm.

Alternatively, the post-treating may include drying, or includes drying and dusting, wherein, the drying may comprise air-drying or drying in a drying apparatus not exceeding 200° C.; dusting may be capable of removing powder particles with a particle size of less than 0.1 mm.

Alternatively, the adsorbent may be a toluene adsorbent.

Another aspect of the present disclosure provides an adsorbent.

The adsorbent may be prepared from industrial vermiculite.

The adsorbent may have a water content of <10% and a dust content may be <1%.

The saturation adsorption amount of the adsorbent for toluene may be 30 mg/g to 200 mg/g, and the adsorption rate from the beginning of adsorption to 2 h may be as high as 67% to 83%.

The adsorbent may be prepared by the method described above.

The adsorbent may be used in the field of gas purification, wastewater treatment, horticulture cultivation, soil improvement and agricultural carriers.

Another aspect of the present disclosure provides applications of the adsorbent. Specifically, industrial vermiculite as an adsorbent in the field of gas purification, wastewater treatment, horticulture cultivation, soil improvement and agricultural carriers.

Alternatively, the gas purification may include adsorption of benzene gases, such as benzene, toluene, ethylbenzene, xylene and other organic gases. Further alternatively, it may be used for the adsorption of toluene with good adsorption effect.

The adsorbent may be the adsorbent described above.

The application may comprise: obtaining an adsorbent using the method described above, and then adsorbing the benzene gas using the adsorbent.

Another aspect of the present disclosure provides an application of industrial vermiculite as an adsorbent for benzene gas. Wherein the benzene gas may comprise at least one of benzene, toluene, ethylbenzene and xylene.

Another aspect of the present disclosure provides a method for adsorption of benzene gas, wherein, the method utilizes industrial vermiculite for adsorption of benzene gas, the benzene gas comprising at least one of benzene, toluene, ethylbenzene and xylene.

Compared with the related art, the beneficial effects of the present disclosure may include at least one of the following:
(1). the industrial vermiculite adsorbent prepared by the present disclosure is a typical inorganic non-metallic mineral material with high cation exchange capacity (up to about 180 mmol/100 g), large internal specific surface area (up to 750 m²/g), strong adsorption of toluene (the adsorption capacity may reach 30˜200 mg/g in two hours) and light porous (capacity of only 50˜200 kg/m³). The advantages of toluene adsorption.
(2). The adsorbents prepared from industrial vermiculite of the present disclosure may be used for the adsorption and purification of gases containing benzene, such as benzene, ethylbenzene, xylene, etc. in industrial production, as well as for applications in horticulture planting, soil improvement and agricultural carriers
(3). the raw and auxiliary materials used in the production of the present disclosure are low in price and excellent in performance, with good economic and social benefits.
(4). the industrial vermiculite adsorbent prepared in the present disclosure is short cylindrical or spherical in shape, and the vermiculite crystal layer structure is not destroyed during the preparation process, and still has the diffraction characteristics of vermiculite, vermiculite-gold mica interlayer minerals and gold mica on the XRD diffraction pattern.
(5). The preparation method of the adsorbent described in the present disclosure is simple, green, low cost of production, easy to scale production, and the adsorbent is not easy to age and easy to recycle.

### BRIEF DESCRIPTION OF DRAWINGS

The accompanying drawings which form part of this application are used to provide a further understanding of the present disclosure, and the above and other objectives and/or features of the present disclosure will become clearer by the following description in conjunction with the accompanying drawings, in which:

FIG. 1 shows a schematic flow diagram of a method for preparing a toluene adsorbent from industrial vermiculite in exemplary embodiment 1 of the present disclosure;

FIG. 2A shows a physical view of the industrial vermiculite fine flakes of the present disclosure;

FIG. 2B shows a grayscale diagram of FIG. 2A;

FIG. 3 shows an XRD diagram of the adsorbent of an exemplary embodiment of the present disclosure; and

FIG. 4 shows a morphological view of the appearance of the adsorbent of an exemplary embodiment of the present disclosure.

FIG. 5 shows an XRD diagram of a regenerated toluene adsorbent of an exemplary embodiment of the present disclosure.

### DETAILED DESCRIPTION

Hereinafter, the present disclosure will be described in detail in connection with exemplary embodiments and the accompanying drawings, but the following embodiments are intended only for the purpose of assisting in the understanding of the technology of the present disclosure and shall not be used as a further limitation on the scope of protection of the present disclosure.

The term “and/or” includes any one and any combination of any two or more of the associated listed items. At least one of X, Y, or Z” may be construed as X only, Y only, Z only, or any combination of two or more of X, Y, and Z, such as, for instance, XYZ, XYY, YZ, and ZZ.

### Exemplary Embodiment 1

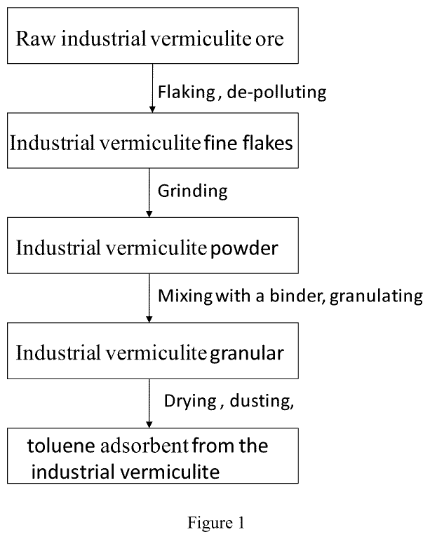

This exemplary embodiment provides a method for preparing a toluene adsorbent from industrial vermiculite. FIG. 1 illustrates a flowchart of a method of preparing an adsorbent of the present disclosure, which, as shown in FIG. 1, may include the following steps:

S01: The raw industrial vermiculite ore is flaked and de-polluted to obtain industrial vermiculite fine flakes.

In this embodiment, the main mineral composition of the industrial vermiculite may include vermiculite, regular and irregular interlayer minerals of vermiculite-gold mica crystal layer, regular and irregular interlayer minerals of vermiculite-black mica crystal layer and regular and irregular interlayer minerals of vermiculite-chlorite crystal layer, and a small amount of impurity minerals such as gold mica and/or black mica, etc.

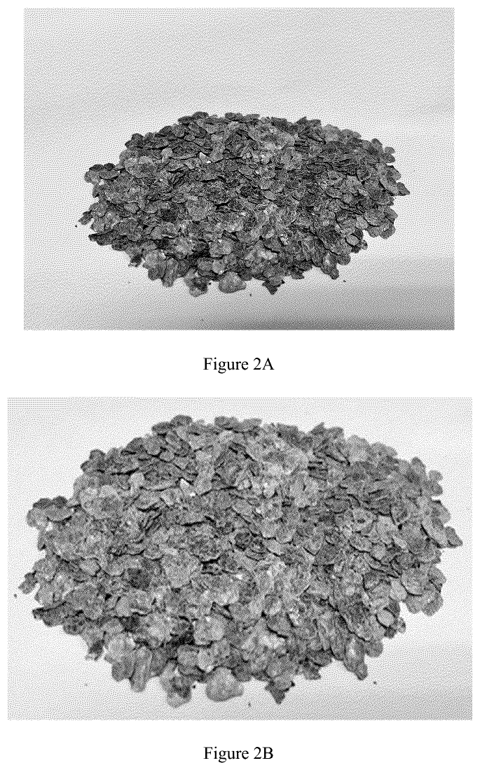

In this embodiment, the industrial vermiculite fine flakes are shown in FIGS. 2A and 2B may be brownish yellow or dark green with a greasy sheen.

In this embodiment, the cation exchange capacity of industrial vermiculite fine flakes may be 30 to 180 mmol/100 g, such as 40 mmol/100 g, 50 mmol/100 g, 70 mmol/100 g, 100 mmol/100 g, 120 mmol/100 g, 145 mmol/100 g, 160 mmol/100 g, 175 mmol/100 g, etc.

S02: The industrial vermiculite fine flakes are grinded to obtain industrial vermiculite powder.

In this embodiment, the particle size of industrial vermiculite powder may be −100 mesh to −325 mesh, i.e., can pass 100 mesh sieve which is the coarsest sieve to can pass 325 mesh sieve which is the finest sieve, and in between there are different sieves that can pass 200 mesh, 250 mesh, etc.), i.e., <0.15 mm to <0.044 mm, such as −100 mesh, −150 mesh, −200 mesh, −250 mesh, −300 mesh, −325 mesh, etc. Among them, −100 mesh means the powder can pass 100 mesh sieves, i.e. the powder under the sieve of 100 mesh sieves, and −325 mesh means the powder can pass 325 mesh sieves, i.e. the powder under the sieve of 325 mesh sieves. The finer the industrial vermiculite powder is ground, the better the adsorption performance. When the particle size is larger than −100 mesh (referring to the sieve on the 100 mesh sieve), the adsorption rate is low and the adsorption effect is not good; if the particle size is less than −325 mesh (referring to the selection of the sieve powder under the sieve powder mesh larger than 325 mesh sieve, such as 350 mesh sieve under the sieve powder), the powder is too fine, and the energy consumption loss of the equipment when the vermiculite grinding is large.

S03: The industrial vermiculite powder is mixed with the binder and granulated to obtain the industrial vermiculite granular.

In this embodiment, as an embodiment of the present disclosure, the binder may comprise an inorganic binder. The inorganic binder may include at least one of bentonite powder, kaolin powder, alutite clay powder, seafoam clay powder, and illite clay powder. The mass ratio of the industrial vermiculite powder mixed with the inorganic binder may be 1:0.2 to 0.8, such as 1:0.25, 1:0.4, 1:0.5, 1:0.75, etc.

In an embodiment, the inorganic binder may be mixed with water first to get inorganic binder slurry and then mixed with industrial vermiculite powder for granulation, but the disclosure is not limited to this, and it is also possible to directly mix inorganic binder, industrial vermiculite powder and water for granulation. The amount of water may be chosen according to the actual needs, and it can meet the granulation molding and the industrial vermiculite granule body without sticking to each other. For example, the amount of water added may be 6-10% of the total amount of the industrial vermiculite powder, the bonding agent and water in terms of mass percentage.

As another embodiment of the present disclosure, the binder may comprise an organic binder. The organic binder may include at least one of sodium carboxymethyl cellulose, polyacrylamide, polyvinyl alcohol, and MS modified silane. The mass ratio of the industrial vermiculite powder to the organic binder may be 1:0.02 to 0.08, such as 1:0.03, 1:0.04, 1:0.05, 1:0.07, 1:0.075, etc.

In an embodiment, the organic binder is mixed with water first to get the aqueous solution of the organic binder, and then mixed with industrial vermiculite powder for granulation. The amount of water may be chosen according to the actual needs, and it can meet the granulation molding and the industrial vermiculite granule body without sticking to each other. For example, the aqueous solution of the organic binder mass percentage concentration is 1.5%-7.6%.

As a further embodiment of the present disclosure, the binder used may include both the inorganic binder and the organic binder described above. In this case, the mass ratio of industrial vermiculite powder, inorganic binder and organic binder may be 1:0.15 to 0.6 (e.g. taking the values 0.16, 0.2, 0.4, 0.5, 0.58, etc.): 0.015 to 0.06 (e.g. taking the values 0.018, 0.02, 0.04, 0.05, 0.058, etc.).

The mass ratio of industrial vermiculite powder mixed with binder in the present disclosure is one of the important factors affecting the structure and performance of industrial vermiculite granular. Wherein, if the amount of the binder is too little, the industrial vermiculite powder cannot be bonded, which may lead to granulation failure and failure to produce or production of inferior industrial vermiculite granular; and when the amount of binder is too much, the pore structure of the produced industrial vermiculite granular is clogged and the specific surface area is reduced, which leads to the reduction of the adsorption capacity of industrial vermiculite toluene adsorbent.

In this embodiment, the pelletizing method employed in the present disclosure may include an extruder extrusion pelletizing method or a rotary pelletizing method. The rotary granulation method may include a circular pot rotary granulation method or a disc rotary granulation method.

In this embodiment, the morphology of the industrial vermiculite granule may include cylindrical and spherical.

Wherein, the cylindrical granules may have a diameter of 1 mm to 5 mm, for example, 1.5 mm, 2 mm, 3 mm, 4 mm, 4.5 mm, etc., and a length of 2 mm to 10 mm, for example, 2.5 mm, 3 mm, 4 mm, 5 mm, 7 mm, 8 mm, 9 mm, 9.5 mm, etc.

The diameter of the spherical granules can be 1 mm to 5 mm, for example, 1.2 mm, 2 mm, 3 mm, 4 mm, 4.8 mm, etc. By controlling the shape and size of the granules within the above requirements, it is possible to ensure sufficient contact between the adsorbent and the benzene molecules and achieve better adsorption performance.

S04: The industrial vermiculite granular is post-treated to obtain an adsorbent.

In this embodiment, the post-treatment may include drying. The adsorbent obtained after drying has better adsorption properties.

Wherein, drying may be done by air-drying or drying. Drying may be carried out in drying equipment not exceeding 200° C. The drying temperature is controlled between 50 and 200° C. When the drying temperature is lower than 50° C., the industrial vermiculite granular is not easy to dry and the dehydration efficiency is low, and when it is higher than 200° C., the vermiculite in the industrial vermiculite granular expands due to heating, which causes the vermiculite granular to break and makes the granulation effect poor or fail. Alternatively, the drying temperature is controlled between 50° C. and 180° C.

Further, after drying, the post-treatment step may also include dust removal.

Dust removal can remove the powder particles with particle size less than 0.1 mm from the dried industrial vermiculite granules, because the particles with too small a particle size are easy to block the pores between the granules, which affects the flow of gas between the granules, and then affects the adsorption rate and adsorption effect of the adsorbent, and the particles with too small a particle size are also easy to cause the dust to fly. After dust removal particles that is <0.1 mm may be used as raw material to join the granulation process for re-granulation. Dust removal can be done with sieving or industrial vacuum equipment.

The adsorbent prepared by the present disclosure can be used for the adsorption and purification of benzene gases, such as organic gases like benzene, toluene, ethylbenzene and xylene. The adsorbent prepared by the present disclosure can also be used for the treatment of wastewater. The adsorbent prepared by the present disclosure can also be used in the fields of horticulture planting, soil improvement and agricultural carrier.

### Exemplary Embodiment 2

This exemplary embodiment provides an adsorbent. In an exemplary embodiment, the adsorbent may be prepared by the method in Exemplary Example 1.

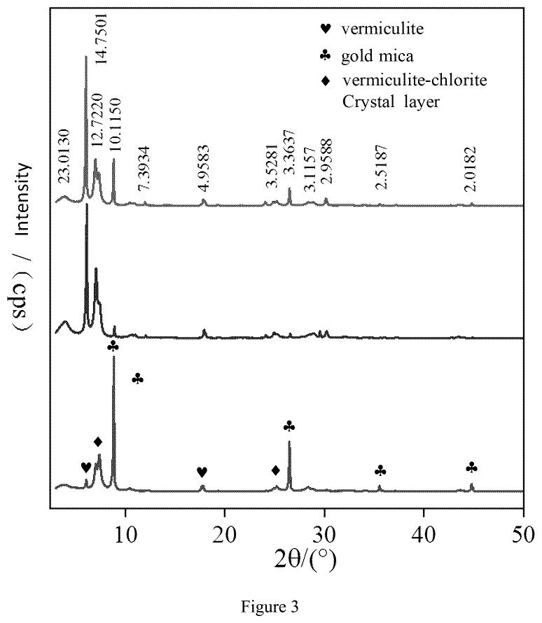

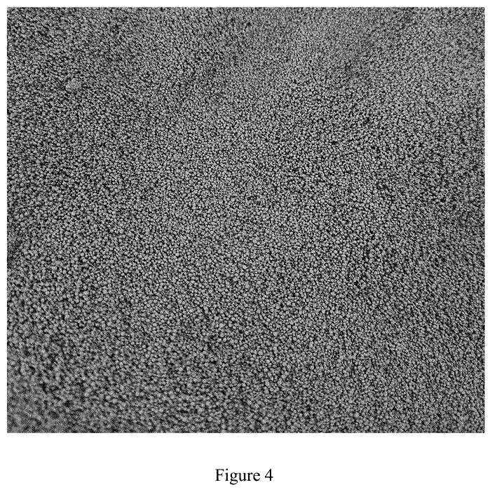

FIG. 3 shows an XRD diagram of the adsorbent of an exemplary embodiment of the present disclosure. Wherein, the XRD patterns of the adsorbents prepared from different particle sizes (−300 mesh, −200 mesh, and −100 mesh) of industrial vermiculite powder are shown from top to bottom, respectively. FIG. 4 shows an appearance morphology of the industrial vermiculite granules (i.e., the adsorbent) obtained from an exemplary embodiment of the present disclosure, where the average particle size of the granules is 1 mm±0.2 mm.

The adsorbent of this disclosure can be short cylindrical or spherical, and the vermiculite crystal layer structure was not destroyed during the preparation process. As shown in FIG. 3, the adsorbent still has the diffraction characteristics of vermiculite, vermiculite-gold mica interlayer minerals and gold mica on the XRD diffraction pattern.

The industrial vermiculite adsorbent prepared in the present disclosure is a typical inorganic nonmetallic mineral material with the advantages of high cation exchange capacity, large internal specific surface area, strong adsorption of benzene and light porosity. Wherein, the cation exchange capacity can reach up to about 180 mmol/100 g, the internal specific surface area can reach 750 m²/g, and the lightweight porous capacity is only 50˜200 kg/m³.

The saturation adsorption amount of toluene may be 30 mg/g to 200 mg/g, such as 31 mg/g, 40 mg/g, 50 mg/g, 80 mg/g, 100 mg/g, 120 mg/g, 150 mg/g, 180 mg/g, and 198 mg/g. The adsorption rate of the adsorbent is fast, and the adsorption amount of the adsorbent may be as high as 67% to 83% of the saturation adsorption amount from the beginning of adsorption to 2 h.

The water content of the adsorbent of the present disclosure is <10%, e.g. 9%, 8%, etc., and the dust content thereof is <1%, e.g. 0.8%, 0.7%, 0.5%, etc.

### Exemplary Embodiment 3

This exemplary embodiment provides applications of the adsorbent.

The applications may include an application in the adsorption and purification of benzene gas, such as for the adsorption and purification of toluene gas in industrial production, and also for the adsorption of organic gases such as benzene, ethylbenzene and xylene from exhaust gases.

The applications may also include applications in wastewater treatment for adsorption of heavy metal ions in industrial or domestic wastewater. For example, adsorption of heavy metal ions Cr³⁺, Cu²⁺, Pb²⁺, Ag⁺, Cd²⁺, etc. in water bodies. Wherein, the maximum adsorption capacities of 60 mg/g and 167 mg/g for Cd²⁺ and Pb²⁺, respectively. This is related to the hydrated cation layer with exchangeability in the vermiculite interlayer domain. During the adsorption process heavy metal contaminants in the water column are ion-exchange adsorbed with the exchangeable cations of vermiculite such as Ca²⁺, Na⁺, Mg²⁺, etc.

The applications may also include use in horticultural plantings, soil amendments, and agricultural carriers. Specific applications may be applied during planting, fertilization and soil tillage.

### Exemplary Embodiment 4

This exemplary embodiment provides an application of the industrial vermiculite as an adsorbent for a benzene gas, the benzene gas comprising at least one of benzene, toluene, ethylbenzene and xylene.

### Exemplary Embodiment 5

This exemplary embodiment provides a method for desorption of industrial vermiculite toluene adsorbent to recover toluene and regeneration of the adsorbent.

The method may include the steps of: placing the industrial vermiculite toluene adsorbent saturated with adsorption in a toluene distillation unit for heating treatment, obtaining a mixture of gas containing water vapor and toluene molecules in the exhaust pipe guide outlet, obtaining the desorbed industrial vermiculite toluene adsorbent in the heating treatment unit; guiding the obtained mixture of gas containing water vapor and toluene molecules to a condensing unit for condensation treatment, and obtaining a mixed liquid with the upper layer being toluene and the lower layer being water after condensation is toluene and the lower layer is water; the obtained mixed liquid is left, stratified, and then subjected to liquid separation treatment to obtain liquid toluene; the obtained desorbed industrial vermiculite toluene adsorbent is post-processed to obtain regenerated industrial vermiculite toluene adsorbent.

In this embodiment, the toluene distillation unit may be an enclosed device with inlet, distillation kettle body, heating and control unit and gas mixture guide outlet, etc., wherein, the role of the heating and control unit is to regulate the temperature and time of heating.

The heating treatment unit is a structural unit (platform) inside the distillation kettle body, the purpose of which is to increase the temperature in the distillation kettle and desorb the toluene in the industrial vermiculite toluene adsorbent placed therein to be desorbed into toluene gas.

In an embodiment, the heating treatment conditions may be: heating temperature of 50° C. to 180° C.

In an embodiment, the condensing device mainly comprises a straight condensing tube, a liquid collection tank, etc.

In an embodiment, the condensing device is free of any air leakage under operating conditions.

In an embodiment, the mixed liquid resting time may be 20 min to 1 h.

In an embodiment, the partitioning treatment is to release the aqueous solution from the lower outlet of the liquid collecting tank while obtaining liquid toluene.

In an embodiment, the post-treatment may comprise a sieving treatment and a heating and drying treatment.

The sieving is to remove the fines less than 1 mm, and the obtained sieves are the first regenerated adsorbent. The fines under the sieve less than 1 mm are granulated to obtain granular bodies with diameters of 1 mm to 5 mm, and this is the second regenerated adsorbent.

The heating and drying treatment is to heat the granular body at a temperature of 55° C.-180° C. When the heating temperature is lower than 55° C., the adsorbent drying rate is slow, and when it is higher than 180° C., the adsorbent will be heated and expanded into expanded vermiculite, resulting in the adsorbent rupture and poor adsorption performance; the heating time may be 20 min-5 h, and when it is lower than 20 min, the adsorbent may not be dried and the water content is large, and when it is higher than 5 h, the equipment energy consumption Increase; the moisture content of the adsorbent after drying is less than 10%.

In this embodiment, the obtained toluene liquid may continue to be used as a raw material for chemical production.

In this embodiment, the regenerated industrial vermiculite toluene adsorbent has a spherical shape, the structure remains unchanged and still has adsorption properties and can be recycled 10 times to 30 times.

### Exemplary Embodiment 6

The present exemplary embodiment provides an adsorbent which is a regenerated industrial vermiculite adsorbent (which may be referred to as a regenerated adsorbent). The regenerated adsorbent may be a product obtained from the preparation of the exemplary embodiments 1, 2 or 3 as described above.

The regenerated adsorbent prepared by the present disclosure has water content of 10% or less (i.e., <10%). The water content will affect the adsorption effect of the subsequent regenerated adsorbent on toluene. If the water content of the regenerated adsorbent is >10%, a large number of water molecules in the adsorbent will occupy the adsorption sites of the vermiculite crystal layer, resulting in fewer adsorption sites occupied by toluene, less adsorption of toluene and a decrease in the adsorption effect, so it is better to maintain the water content at least at 10% and below, such as 10%, 9%, 7%, 5%, etc.

The regenerated adsorbent prepared by the present disclosure has a spherical shape. The structure of the regenerated adsorbent remains unchanged and the regenerated adsorbent is verified to still have adsorption performance by reabsorption and can be recycled 10 times ˜30 times, such as 11 times, 15 times, 17 times, 22 times, 25 times, 29 times, etc.

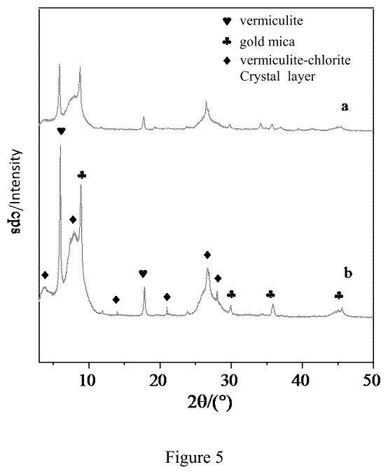

FIG. 5 illustrates the XRD diagram of the regenerated industrial vermiculite toluene adsorbent of the present disclosure, the curve a in the figure is the XRD diagram of the first regenerated adsorbent after 15 times of resorption, and the curve b in the figure is the XRD diagram of the industrial vermiculite toluene adsorbent that has not adsorbed toluene, from which it can be seen that after adsorption of toluene, the diffraction peaks of each phase change significantly, and the vermiculite and vermiculite-gold mica interlayer, the intensity of the diffraction peaks of vermiculite and vermiculite-aurichitic interlayer decreased significantly or disappeared, and the intensity of the diffraction peaks of aurichitic mica also decreased. It shows that toluene enters the vermiculite interlayer domain of vermiculite and vermiculite-gold mica interlayer minerals, which leads to the periodic destruction of the structure of vermiculite and vermiculite-gold mica interlayer minerals, and the degree of order decreases, and no or very weak diffraction peaks are produced, so the intensity of diffraction peaks decreases.

In order to better understand the above exemplary embodiments, they are further described below with specific examples.

### Example 1

The obtained industrial vermiculite fine flakes were separately ground to −100 mesh to obtain industrial vermiculite powder.

The obtained industrial vermiculite powder and bentonite powder which is inorganic binder were mixed evenly according to the mass percentage of 1:0.2, 1:0.3, 1:0.4, 1:0.5 and 1:0.8, respectively, and granulated by disc rotary granulation method, and the granulation shape was a ball shape of 3 mm diameter to obtain industrial vermiculite granulars in different ratios of the industrial vermiculite powder and the inorganic binder (i.e. bentonite).

The industrial vermiculite granules obtained under different ratios were all dried at a temperature of 50° C. and sieved to remove the powder particles with particle size less than 0.1 mm to obtain five adsorbents, all of which contained less than 10% water.

For each of the five adsorbents, 100 g was added to five closed containers containing the same toluene exhaust gas to make full contact with toluene. The adsorption capacity of the five adsorbents reached 68%, 78%, 85%, 83% and 62% of the saturation adsorption capacity for toluene from the beginning of adsorption to 2 h. At 6 h, the adsorption capacity of each adsorbent basically reached saturation, and the saturation adsorption capacities were 89 mg/g, 122 mg/g, 136 mg/g, 123 mg/g and 79 mg/g, respectively.

### Example 2

The obtained industrial vermiculite fine flakes were separately ground to −150 mesh to obtain industrial vermiculite powder.

The obtained industrial vermiculite powder and bentonite powder which is an inorganic binder were mixed evenly according to the mass percentage of 1:0.2, 1:0.3, 1:0.4, 1:0.5, 1:0.8 respectively, and then granulated by disc rotating granulation method, and the granulation shape was a ball shape of 1 mm diameter to obtain industrial vermiculite granulars in different ratios of the industrial vermiculite powder and the inorganic binder (i.e. bentonite).

The industrial vermiculite granules obtained under different ratios were all dried at a temperature of 70° C. and sieved to remove the powder particles with particle size less than 0.1 mm to obtain five adsorbents, all of which contained less than 10% of water content.

For each of the five adsorbents, 100 g was added to five closed containers containing the same toluene exhaust gas to make full contact with toluene. The adsorption capacity of the five adsorbents reached 73%, 79%, 88%, 85%, 71% of the saturation adsorption capacity for toluene from the beginning of adsorption to 2 h. At 6 h, the adsorption capacity of each adsorbent basically reached saturation, and the saturation adsorption capacities were 92 mg/g, 128 mg/g, 141 mg/g, 124 mg/g and 86 mg/g, respectively.

### Example 3

The obtained industrial vermiculite fine flakes were separately ground to −200 meshes to obtain industrial vermiculite powder.

The obtained industrial vermiculite powder and kaolin powder which is a inorganic binder were mixed well according to the mass percentages of 1:0.2, 1:0.3, 1:0.4, 1:0.5, 1:0.8, and then granulated by disc rotary granulation method, and the granulation shape was a ball shape of 1 mm diameter to obtain industrial vermiculite granular in different ratios of the industrial vermiculite powder and the inorganic binder (i.e. kaolin).

The industrial vermiculite granules obtained under different ratios were all dried at a temperature of 105° C. and sieved to remove the powder particles with particle size less than 0.1 mm to obtain five adsorbents, all of which contained less than 10% water.

For each of the five adsorbents, 100 g was added to five closed containers containing the same toluene exhaust gas to make full contact with toluene. The adsorption capacity of the five adsorbents reached 72%, 79%, 85%, 83%, 70% of the saturation adsorption capacity for toluene from the beginning of adsorption to 2 h. At 6 h, the adsorption capacity of each adsorbent basically reached saturation, and the saturation adsorption capacities were 88 mg/g, 122 mg/g, 128 mg/g, 109 mg/g and 82 mg/g, respectively.

### Example 4

The obtained industrial vermiculite fine flakes were separately ground to −250 mesh to obtain industrial vermiculite powder.

The obtained industrial vermiculite powder and a sodium carboxymethyl cellulose which is an organic binder were mixed evenly according to the mass percentages of 1:0.02, 1:0.04, 1:0.05, 1:0.06, 1:0.08, and then granulated by disc rotary granulation method, and the shape of granulation was 1 mm diameter ball to obtain industrial vermiculite granulars in different ratios of the industrial vermiculite powder and the organic binder (i.e. sodium carboxymethyl cellulose).

The industrial vermiculite granules obtained under different ratios were all dried at a temperature of 120° C. and sieved to remove the powder particles with particle size less than 0.1 mm to obtain five adsorbents, all of which contained less than 10% water.

For each of the five adsorbents, 100 g was added to five closed containers containing the same toluene exhaust gas to make full contact with toluene. The adsorption capacity of the five adsorbents reached 75%, 82%, 93%, 84%, 80% of the saturation adsorption capacity for toluene from the beginning of adsorption to 2 h. At 6 h, the adsorption capacity of each adsorbent basically reached saturation, and the saturation adsorption capacities were 100 mg/g, 156 mg/g, 167 mg/g, 149 mg/g and 102 mg/g, respectively.

### Example 5

The obtained industrial vermiculite fine flakes were separately ground to −325 mesh to obtain industrial vermiculite powder.

The obtained industrial vermiculite powder was mixed with inorganic binder (i.e. bentonite) powder and organic binder (i.e. sodium carboxymethyl cellulose) at mass percentages of 1:0.15:0.06, 1:0.2:0.04, 1:0.25:0.02, 1:0.45:0.02, 1:0.55:0.015 respectively, and then granulated by disc rotary granulation method, and the granulation shape was a ball shape of diameter 1 mm ball shape, to obtain industrial vermiculite granulars under different ratios of industrial vermiculite powder and inorganic binder bentonite, inorganic binder (i.e. bentonite) and organic binder (i.e. sodium carboxymethyl cellulose).

The industrial vermiculite granules obtained under different ratios were all dried at a temperature of 150° C. and sieved to remove the powder particles with particle size less than 0.1 mm to obtain five adsorbents, all of which contained less than 10% water.

For each of the five adsorbents, 100 g was added to five closed containers containing the same toluene exhaust gas to make full contact with toluene. The adsorption capacity of the five adsorbents reached 74%, 85%, 89%, 86%, 81% of the saturation adsorption capacity for toluene from the beginning of adsorption to 2 h. At 6 h, the adsorption capacity of each adsorbent basically reached saturation, and the saturation adsorption capacities were 98 mg/g, 127 mg/g, 131 mg/g, 113 mg/g and 92 mg/g, respectively.

### Example 6

The obtained industrial vermiculite fine flakes were separately ground to −325 mesh to obtain industrial vermiculite powder.

The obtained industrial vermiculite powder and bentonite powder which is an inorganic binder were mixed evenly according to the mass percentage of 1:0.2, 1:0.3, 1:0.4, 1:0.5, 1:0.8 respectively, and then granulated by disc rotating granulation method, and the granulation shape was a ball shape of 1 mm diameter to obtain industrial vermiculite granulars in different ratios of the industrial vermiculite powder and the inorganic binder (i.e. bentonite).

The industrial vermiculite granules obtained under different ratios were all dried at a temperature of 180° C. and sieved to remove the powder particles with particle size less than 0.1 mm to obtain five adsorbents, all of which contained less than 10% water.

For each of the five adsorbents, 100 g was added to five closed containers containing the same ethylbenzene exhaust gas to make full contact with ethylbenzene. The adsorption capacity of the five adsorbents reached 72%, 82%, 90%, 86% and 80% of the saturation adsorption capacity for toluene when tested from the beginning of adsorption to 2 h. At 6 h, the adsorption capacity of each adsorbent basically reached saturation, and the saturation adsorption capacities were 95, 132, 138, 113 and 94 mg/g, respectively.

### Example 7

The industrial vermiculite toluene adsorbent with the highest saturation adsorption capacity (i.e. the third adsorbent with 85% of the saturation adsorption capacity) in Example 1 is placed in a distillation unit with closed devices such as inlet, distillation kettle body, heating and control unit and gas conductor outlet for heating treatment at a temperature of 50° C. and a heating time of 2 h.

A gas mixture containing water vapor and toluene molecules is obtained at the outlet of the exhaust duct, and the desorbed industrial vermiculite toluene adsorbent is obtained at the heating and processing unit.

The obtained gas mixture containing water vapor and toluene molecules is guided to a straight condenser without any air leakage under working conditions for condensation, and a liquid mixture with toluene on top and water on the bottom is obtained in the liquid collection tank. The obtained mixed liquid is left to stratify for 20 min, and then the aqueous solution is released from the lower outlet of the collection tank, and liquid toluene is obtained at the same time.

The obtained desorbed industrial vermiculite toluene adsorbent is sieved and the fine powder less than 1 mm is removed, and the obtained sieve top is the first regenerated adsorbent, and the fine powder under the sieve is granulated to obtain a granular body with a diameter of 1 mm, which is the second regenerated adsorbent. The regenerated first adsorbent and the second adsorbent were heated at 55° C. and the heating time was 5 h to obtain the regenerated industrial vermiculite toluene adsorbent.

The regenerated industrial vermiculite toluene adsorbent was spherical in shape, the structure remained unchanged, and the moisture content was 10% after drying.

The first regenerated adsorbent and the second regenerated adsorbent were subjected to toluene adsorption and desorption experiments for several times, and it was found that they could be recycled for 30 times and 28 times, respectively; and both showed that the adsorption amount of toluene became lower and lower with the increase of the reuse times.

### Example 8

The industrial vermiculite toluene adsorbent with the highest saturation adsorption capacity (i.e. the third adsorbent with 85% of the saturation adsorption capacity) in Example 3 is placed in a distillation unit with closed devices such as inlet, distillation kettle body, heating and control unit and gas conductor outlet for heating treatment at a temperature of 80° C. and a heating time of 1 h.

A mixture of gas containing water vapor and toluene molecules is obtained at the outlet of the exhaust pipe, and the desorbed industrial vermiculite toluene adsorbent is obtained at the heating and processing unit.

The obtained gas mixture containing water vapor and toluene molecules is guided to a straight condenser without any air leakage under working conditions for condensation, and a liquid mixture with toluene on top and water on the bottom is obtained in the liquid collection tank. The obtained mixed liquid is left to stratify for 30 min, and then the aqueous solution is released from the lower outlet of the collection tank, and liquid toluene is obtained at the same time.

The obtained desorbed industrial vermiculite toluene adsorbent is sieved and the fine powder less than 1 mm is removed, and the obtained sieve top is the first regenerated adsorbent, and the fine powder under the sieve is granulated to obtain a granular body with a diameter of 2 mm, which is the second regenerated adsorbent. The regenerated first adsorbent and the second adsorbent were heated at 80° C. and the heating time was 4 h to obtain the regenerated industrial vermiculite toluene adsorbent.

The regenerated industrial vermiculite toluene adsorbent had a spherical shape, the structure remained unchanged, and the moisture content was 9% after drying.

The first regenerated adsorbent and the second regenerated adsorbent were subjected to toluene adsorption and desorption experiments for several times, and it was found that they could be recycled 26 times and 24 times, respectively; and both showed that the adsorption amount of toluene became lower and lower with the increase of the reuse times.

### Example 9

The industrial vermiculite toluene adsorbent with the highest saturation adsorption capacity (i.e. the third adsorbent with 93% of the saturation adsorption capacity) in Example 4 is placed in a distillation unit with closed devices such as inlet, distillation kettle body, heating and control unit and gas conductor outlet for heating treatment at a temperature of 120° C. and a heating time of 40 min.

A mixture of gas containing water vapor and toluene molecules is obtained at the outlet of the exhaust pipe, and the desorbed industrial vermiculite toluene adsorbent is obtained at the heating and processing unit.

The obtained gas mixture containing water vapor and toluene molecules is guided to a straight condenser without any air leakage under working conditions for condensation, and a liquid mixture with toluene on the top and water on the bottom is obtained in the liquid collection tank. The obtained mixed liquid is left to stratify for 1 h, and then the aqueous solution is released from the lower outlet of the collection tank, while the liquid toluene is obtained.

The obtained desorbed industrial vermiculite toluene adsorbent is sieved and the fines less than 1 mm are removed, and the obtained sieve top is the first regenerated adsorbent, and the fines under the sieve are granulated to obtain a granular body with a diameter of 3 mm, which is the second regenerated adsorbent. The regenerated first adsorbent and the second adsorbent were heated at 150° C. and the heating time was 2 h to obtain the regenerated industrial vermiculite toluene adsorbent.

The regenerated industrial vermiculite toluene adsorbent had a spherical shape, the structure remained unchanged, and the moisture content was 6% after drying.

The first regenerated adsorbent and the second regenerated adsorbent were subjected to toluene adsorption and desorption experiments for several times, and it was found that they could be recycled 25 times and 25 times, respectively; and both showed that the adsorption amount of toluene became lower and lower with the increase of the reuse times.

### Example 10

The industrial vermiculite toluene adsorbent with the highest saturation adsorption capacity (i.e. the third adsorbent with 89% of the saturation adsorption capacity) in Example 5 is placed in a distillation unit with closed devices such as inlet, distillation kettle body, heating and control unit and gas conductor outlet for heating treatment at a temperature of 180° C. and a heating time of 20 min.

A mixture of gas containing water vapor and toluene molecules is obtained at the outlet of the exhaust pipe, and the desorbed industrial vermiculite toluene adsorbent is obtained at the heating and processing unit.

The obtained gas mixture containing water vapor and toluene molecules is guided to a straight condenser without any air leakage under working conditions for condensation, and a liquid mixture with toluene on the top and water on the bottom is obtained in the liquid collection tank. The obtained mixed liquid is left to stratify for 1 h, and then the aqueous solution is released from the lower outlet of the collection tank, while the liquid toluene is obtained.

The obtained desorbed industrial vermiculite toluene adsorbent is sieved and the fine powder less than 1 mm is removed, and the obtained sieve top is the first regenerated adsorbent, and the fine powder under the sieve is granulated to obtain a granular body with a diameter of 5 mm, which is the second regenerated adsorbent. The regenerated first adsorbent and the second adsorbent were heated at 180° C. and the heating time was 20 min to obtain the regenerated industrial vermiculite toluene adsorbent.

The regenerated industrial vermiculite toluene adsorbent was spherical in shape, the structure remained unchanged, and the moisture content was 5% after drying.

The first regenerated adsorbent and the second regenerated adsorbent were subjected to toluene adsorption and desorption experiments for several times, and it was found that they could be recycled for 17 and 18 times, respectively; and both showed that the adsorption amount of toluene became lower and lower with the increase of the reuse times.

Although the present disclosure has been described above in conjunction with exemplary embodiments, it should be clear to those skilled in the art that various modifications and changes can be made to the exemplary embodiments of the present disclosure without departing from the spirit and scope defined by the claims change.

What is claimed is:

1. A method for preparing an adsorbent, wherein, the method comprises the following steps:
flaking and de-polluting the raw industrial vermiculite ore to obtain industrial vermiculite fine flakes;
grinding the industrial vermiculite fine flakes to obtain industrial vermiculite powder;
mixing the industrial vermiculite powder with a binder and granulating to obtain an industrial vermiculite granular; and
post-treating the industrial vermiculite granular to obtain the adsorbent.

2. The method for preparing the adsorbent according to claim 1, wherein, the cation exchange capacity of the industrial vermiculite fine flakes is 30 to 180 mmol/100 g.

3. The method for preparing the adsorbent according to claim 1, wherein, the particle size of industrial vermiculite powder is in a range of −100 mesh to −325 mesh.

4. The method for preparing the adsorbent according to claim 1, wherein, the binder comprises at least one of an inorganic binder and an organic binder, wherein,
the inorganic binder includes one or more of bentonite powder, kaolin powder, alutite clay powder, seafoam clay powder and illite clay powder;
the organic binder includes one or more of sodium carboxymethyl cellulose, polyacrylamide, polyvinyl alcohol, and MS modified silane.

5. The method for preparing the adsorbent according to claim 4, wherein, under the condition where the binder comprises only the inorganic binder, the mass ratio of the industrial vermiculite powder to the inorganic binder is 1:0.2 to 0.8;
under the condition where the binder comprises only the organic binder, the mass ratio of the industrial vermiculite powder to the organic binder is 1:0.02 to 0.08;
under the condition where the binder includes the inorganic binder and the organic binder, the mass ratio of the industrial vermiculite powder, the inorganic binder and the organic binder is 1: (0.15 to 0.6):(0.015 to 0.06).

6. The method for preparing the adsorbent according to claim 1, wherein, pelletizing methods include extrusion pelletizing method by extruder, circular pot rotary pelletizing method or circular disc rotary pelletizing method.

7. The method for preparing the adsorbent according to claim 1, wherein, the shape of the industrial vermiculite granular includes cylindrical or spherical, wherein,
the cylindrical granular has a diameter of 1 mm to 5 mm and a length of 2 mm to 10 mm;
the spherical granular has a diameter of 1 mm to 5 mm.

8. The method for preparing the adsorbent according to claim 1, wherein, the post-treating includes drying, or includes drying and dusting, wherein,
the drying comprises air-drying or drying in a drying apparatus not exceeding 200° C.;
dusting is capable of removing powder particles with a particle size of less than 0.1 mm.

9. The method for preparing the adsorbent according to claim 1, wherein, the method includes: mixing and granulating the inorganic binder, water and the industrial vermiculite powder to obtain industrial vermiculite granular body, the amount of water added is 6 to 10% of the total amount of industrial vermiculite powder, binder and water; or
mixing the organic binder with water to obtain an aqueous solution of the organic binder, then mixing and granulating with the industrial vermiculite powder to obtain industrial vermiculite granular body, the mass percentage concentration of the aqueous solution of organic binder being 1.5% to 7.6%.

10. The method for preparing the adsorbent according to claim 1, wherein, the adsorbent is a toluene adsorbent.

11. The method for preparing the adsorbent according to claim 1, wherein, the method further comprising:
adsorbing the benzene gas using the adsorbent;
heating the adsorbed adsorbent in a distillation unit to obtain a mixture of gas and a desorbed industrial vermiculite toluene adsorbent; and
post-treating the desorbed industrial vermiculite toluene adsorbent to obtain a regenerated industrial vermiculite toluene adsorbent.

12. The method for preparing the adsorbent according to claim 11, wherein, the heating conditions include: heating temperature 50˜180° C., heating time 20 min˜2 h.

13. The method for preparing the adsorbent according to claim 11, wherein, the post-treatment comprises sieving and heating and drying, wherein
sieving is to remove the fine powder with a particle size less than 1 mm to obtain a sieve top, the sieve top being the first regenerated adsorbent, and to re-granulate the sieve bottom fine powder to obtain a granular body with a diameter of 1 to 5 mm, the granular body being the second regenerated adsorbent;
heating and drying is done by heating the first regenerated adsorbent and/or the second regenerated adsorbent at a temperature of 55 to 180° C. for 20 min to 5 h.

14. The method for preparing the adsorbent according to claim 1, wherein, the regenerated industrial vermiculite toluene adsorbent shape is spherical, the structure remains unchanged, and still has adsorption properties and can be recycled 10 to 30 times.

15. An adsorbent, wherein, the adsorbent is prepared from industrial vermiculite.

16. The adsorbent according to claim 15, wherein, the adsorbent is prepared by a method for preparing the adsorbent, the adsorbent having a water content of <10% and a dust content of <1%, the method comprises the following steps:
flaking and de-polluting the raw industrial vermiculite ore to obtain industrial vermiculite fine flakes;
grinding the industrial vermiculite fine flakes to obtain industrial vermiculite powder;
mixing the industrial vermiculite powder with a binder and granulating to obtain an industrial vermiculite granular; and
post-treating the industrial vermiculite granular to obtain the adsorbent.

17. The adsorbent according to claim 15, wherein, the adsorbent is used in the field of gas purification, wastewater treatment, horticulture cultivation, soil improvement and agricultural carriers.

18. Application of industrial vermiculite as an adsorbent in the field of gas purification, wastewater treatment, horticulture cultivation, soil improvement and agricultural carriers wherein, the gas purification comprises adsorption of a benzene gas, the benzene gas is selected from the group consisting of benzene, toluene, ethylbenzene and xylene.

19. The application according to claim 18, wherein, the adsorbent is prepared from industrial vermiculite, the adsorbent is prepared by a method for preparing the adsorbent, the adsorbent having a water content of <10% and a dust content of <1%, the method comprises the following steps:
flaking and de-polluting the raw industrial vermiculite ore to obtain industrial vermiculite fine flakes;
grinding the industrial vermiculite fine flakes to obtain industrial vermiculite powder;
mixing the industrial vermiculite powder with a binder and granulating to obtain an industrial vermiculite granular; and
post-treating the industrial vermiculite granular to obtain the adsorbent.

20. The application according to claim 18, wherein, the application comprises:
obtaining an adsorbent using a method for preparing the adsorbent, and then adsorbing the benzene gas using the adsorbent, wherein, the method comprises the following steps:
flaking and de-polluting the raw industrial vermiculite ore to obtain industrial vermiculite fine flakes;
grinding the industrial vermiculite fine flakes to obtain industrial vermiculite powder;
mixing the industrial vermiculite powder with a binder and granulating to obtain an industrial vermiculite granular; and
post-treating the industrial vermiculite granular to obtain the adsorbent.
